(19) United States
(12) Patent Application Publication
(10) Pub. No.: US 2004/0071386 A1
(43) Pub. Date: Apr. 15, 2004

(54) Method and apparatus for homogeneous heating in an optical waveguiding structure

(76) Inventors: Joris van Nunen, Winchester, MA (US); Alan D. Heaney, Wakefield, MA (US); Chuck C. Xu, Tewksbury, MA (US); Deepti Pant, Woburn, MA (US); Louay Eldada, Lexington, MA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/410,334

(22) Filed: Apr. 9, 2003

Related U.S. Application Data
(60) Provisional application No. 60/370,957, filed on Apr. 9, 2002.

(51) Int. Cl. G02B 6/12

(52) U.S. Cl. 385/14

(57) ABSTRACT

This invention pertains to a novel design for an integrated optical communications device utilizing the thermo-optic effect to condition, manipulate, or alter an optical signal transmitted thereto.

### FIELD OF THE INVENTION

This invention pertains to a novel design for an integrated optical communications device utilizing the thermo-optic effect to condition, manipulate, or alter an optical signal transmitted thereto.

### BACKGROUND OF THE INVENTION

It is well known in the art that the refractive index of a material varies with temperature. A change in the refractive index of a dielectric material such as a glass or polymer alters the speed of light within that material. Thus, a light wave propagating through a transparent medium will exhibit a phase shift or a deflection as it passes through a region within that medium at a higher or lower temperature than the surrounding regions. This effect, known broadly as the thermo-optic effect, is well known in the art, and is employed in the field of optical communications among others to perform manipulations on optical signals.

Thermo-optic devices are currently employed in the art for integrated optical spatial switches, frequency-selective devices, and phase-sensitive sensors.

Heimala et al, J. Lightwave Tech. 14, 2260-2267 (1996), describes the fabrication of ring resonators that employ thermo-optic components in sensors. A thermo-optic structure is disclosed in which a 3 micrometer thick SiO₂ undercladding layer separates a 525 micrometer Si substrate from Si₃N₄ optical waveguide structures that are in turn separated by a 2 micrometer thick layer of SiO₂ from poly-Si resistors having Al electrical contacts. Heimala discloses the bridge structures of Sugita et al, Trans. IEICE, E73, 105-108 (1990), which were developed to partially isolate the heated waveguide structure from the silicon substrate in order to reduce power demands upon heating.

Kasahara et al, IEEE Photonics Tech. Lett., 11(9), 1132-1134 (1999), provides for a method of reducing heat diffusion into the silicon substrate of an integrated thermo-optic switch by creating an extra layer of undercladding 40 micrometers in thickness between the so-called heaters and the Si substrate. FIG. 1 therein shows the structure of Kasahara wherein the thin-film Cr heating element is disposed at the opposite end of the waveguide structure from the substrate.

In all of the embodiments in the art, it is clearly taught to first prepare the waveguide structure on the silicon substrate, with an extra thick “undercladding” layer to provide some thermal isolation for the heated waveguide, and then to deposit in a final step a heating element on the opposite side of the waveguide structure from the silicon substrate. All of these embodiments exhibit a significant temperature gradient across the heated waveguide, including in the core thereof. The concomitant refractive index gradient may introduce undesirable birefringence or polarization dependent loss on an incident optical signal. One further deleterious effect is an undesirable limit to the resolution of a frequency-selective device. Whereas in certain applications, such as optical spatial switches, the relatively small temperature gradient has a negligible effect on performance, the inventors hereof have found that in frequency-selective applications it is highly desirable to minimize the temperature gradient a much as possible.

### SUMMARY OF INVENTION

The present invention provides for a thermo-optic device comprising a heat sink, an optical waveguide, and a heating means, said heating means and said heat sink being both disposed on the same side of said optical waveguide.

Further provided in the present invention is a method for tunably selecting a portion of the frequency spectrum from a frequency domain multiplexed optical signal, the method comprising

Causing a frequency domain multiplexed optical signal to be directed to a thermo-optic device comprising a heat sink, an optical waveguide having a plurality of sides, and a heating means, said heating means and said heat sink being both disposed on the same side of said optical waveguide, and wherein said optical waveguide comprises a Bragg grating; and

Causing said thermo-optic device to be heated to a temperature corresponding to the selection of the desired frequency portion of said frequency spectrum of said frequency domain multiplexed optical signal.

Further provided in the present invention is an integrated optical communications component comprising a plurality of thermo-optic devices at least one of said thermo-optic devices comprising a heat sink, an optical waveguide having a plurality of sides, and a heating means, said heating means and said heat sink being both disposed on the same side of said optical waveguide.

### BRIEF DESCRIPTION OF THE DRAWINGS

FIG. 1 shows a schematic of a typical arrangement in the art.

FIG. 2 shows a schematic of the present invention.

FIG. 3 illustrates a step-by-step method for preparing an embodiment of the present invention.

FIG. 4 depicts the results of a heat transfer simulation study of the thermo-optic device of the present invention.

FIG. 5 depicts the results of a heat transfer simulation study of a thermo-optic device of the art.

### DETAILED DESCRIPTION OF THE INVENTION

In a typical application, the design of a thermo-optic device calls for a trade-off among several design parameters. These include rapidity of “switching time” or “tuning time” which calls for both rapid heating and cooling. Rapidity of heating in turn is determining by the design and power of the heater employed, as well as by the thermal inertia and thermal conductivity of the material to be heated. Cooling time is related to the thermal inertia and thermal conductivity of the material, and the availability of a heat sink. However, it is also desirable to employ as little power as possible, and to make the heater as small as possible. Finally, different applications require different temperature uniformity tolerances in the heated waveguide. Spatial optical switches have been found to be far more tolerant of thermal gradients through the waveguide core than are frequency-selective components such as waveguide-integrated Bragg gratings. In the latter case, any degree of thermal non-uniformity necessarily results in a decrease in resolution of the device. It is thus of particular importance to achieve thermal uniformity in frequency selective integrated optical devices such as Bragg gratings.

This innovation has been achieved herein. The design taught in the art, illustrated schematically in FIG. 1, must necessarily introduce a thermal gradient in the heated waveguide, 1, having core 6 and cladding 5, by virtue of the fact that the heater, 2, is on one side thereof and a heat sink, 3, at lower temperature is disposed on the other side of the waveguide, 1, from said heater, 2. The art cited hereinabove provides methods for reducing the thermal gradient by providing some degree of insulation between the waveguide and the heat sink. However, this can only be of limited value since the heat sink is required to achieve the necessary cooling rates. If the heat sink were excessively isolated from the waveguide, cooling would occur at undesirably low rates.

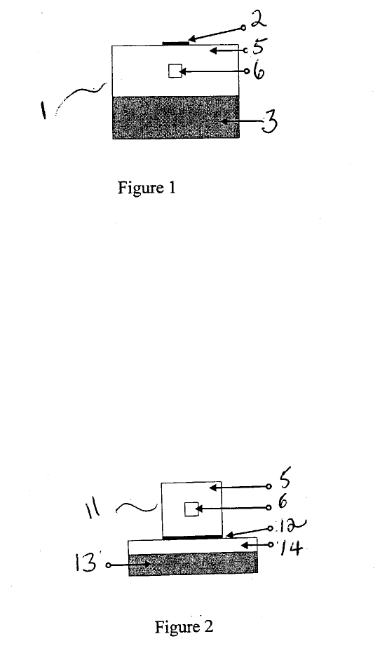

In the thermo-optic device according to the present invention, as illustrated schematically in FIG. 2, the heater, 12, and the heat sink, 13, reside on the same side of the optical waveguide, 11, the heater being interposed between the heat sink and the waveguide. FIG. 2 depicts a preferred embodiment of the invention hereof, further comprising a thermally insulating layer, 14, disposed between said heater, 12, and said heat sink, 13. The result is that the thermo-optic device according to the present invention affords a much reduced thermal gradient across the waveguide during the heating cycle, while during the cooling cycle, the heat sink facilitates cooling. In the present invention, heating and cooling rates of several milliseconds are achieved.

By having the heater in direct thermal contact with the heat sink, a considerable portion of the heat produced will be transferred to the heat sink rather than to the waveguide, necessitating use of a heater that consumes more power than is desired. Since it is desirable to reduce the heat load on the thermo-optic device and minimize the electrical power demands thereof, it has been found in a preferred embodiment that a good balance can be struck among competing design parameters by interposing a thermally insulating layer between the heating means and the heat sink. It is important to emphasize, however, that the thermally insulating layer in the preferred embodiment of the present invention is not the waveguide in the thermo-optic device. It is a fundamental aspect of the present invention that the heating means and the heat sink are disposed on the same side of the optical waveguide serving as the active component of the thermo-optic device of the invention. In a preferred embodiment, a high degree of temperature uniformity is achieved over the desired temperature range of ca. 120° C., using electrical resistive heating on the order of 1 Watt/cm.

In the practice of the invention, the heat sink may be a semiconductor or a conductor (e.g., metal) as may be appropriate to the specific application. Preferably the heat sink is silicon. Most preferably, the surface of the silicon is functionalized to improve adhesion. When a thermally insulating layer is employed as in the preferred embodiment of the invention, the surface of the silicon heat sink is preferably silanized, most preferably with (3-acryloxypropyl)trichlorosilane. While the heat sink need not be of any particular dimensions, it must be chosen to provide the desired degree of cooling. A thickness of ca. 500 micrometers is found to be adequate.

The optical waveguide suitable for the present invention comprises an undercladding, a core, and an overcladding, where the core has a higher refractive index than both the undercladding and the overcladding. Suitable waveguide materials include both polymers and glasses. Suitable polymers are chosen according to their properties. Preferred: polymers that exhibit a temperature dependence of index of refraction, dn/dT, in the range of −1×10⁻⁴/° C. to −4×10⁻⁴/° C., and thermal conductivity in the range of 0.01 to 1 W/m.K. Particularly preferred: photosensitive halogenated acrylates.

Other waveguide materials such as are known in the art may also be employed in the thermo-optic device of the invention. However, they are less preferred because their use requires greater trade-offs between thermal conductivity and the temperature dependence of refractive index. For example, glasses exhibit suitably low thermal conductivity but dn/dT of ca. 1×10⁻⁵/° C. Silicon exhibits dn/dT of ca. 1.8×10⁻⁴/° C., but high thermal conductivity of ca. 83.7 W/m.K. Thus polymeric waveguides are preferred for the practice of the invention.

Further provided in the present invention is a means for heating the waveguide structure. According to the present invention said heating means is disposed on the same side of the optical waveguide as the heat sink. Any suitable heating means is satisfactory for the practice of the present invention. Suitable means include, but are not limited to, electrical resistance heating, radio frequency inductance, microwave heating, heating via a heat transfer fluid. A preferred method of heating is electrical resistance heating. More preferably, the heater comprises a layered structure selected from the group consisting of Cr/Ni/Au, Cr/Au, and Ti/Au when no thermally insulating layer is used and Cr/Ni/Au/Ni/Cr, Cr/Au/Cr, and Ti/Au/Ti when a thermally insulating layer is used. Most preferably the heater comprises a layered structure of Cr/Ni/Au when no thermally insulating layer is used and Cr/Au/Cr when a thermally insulating layer is used.

Although not strictly required in the practice of the present invention, it is highly preferred to incorporate a thermally insulating layer between said heating means and said heat sink. Selection of said thermally insulating requires achieving a balance between excessive drainage of power from the heating means into the heat sink during the heating cycle, and insufficient cooling rate during the cooling cycle. Any thermally insulating material that provides the desired balance is suitable for the practice of the invention. It has been found to be convenient to employ a thickness of 1 to 10 micrometers of polymeric material exhibiting a thermal conductivity in the range of 0.01 to 1 W/m.K, preferably 0.1-0.5 W/m.K.

The process for fabricating the thermo-optic device of the present invention comprises a sequence of steps for applying a layer of material, and a sequence of steps for imposing a pattern onto the applied layer in order to create a component that performs some function. In the typical practice of the invention, a heat sink material having a flat surface has layers applied in sequence followed by patterning steps. Layers of material may be variously applied by means known in the art. Polymeric materials may conveniently be formed by methods including but not limited to spin coating, slot coating, doctor blading, damming, molding, and casting. Spin coating is preferred. Thickness is preferably controlled to ±0.05 micrometers. Glass and semiconductor materials may be formed by such methods as are commonly practiced in the art such as chemical vapor deposition or flame hydrolysis deposition. Typically, the thickness of thus deposited glass layers can be controlled to ±0.01 micrometers.

The layers so formed may be patterned by any convenient method such as is known in the art, including but not limited to direct mask photolithography, mask photolithography/reactive ion etching (RIE), laser direct writing lithography, embossing, stamping, casting, molding, and simply cutting and trimming. Direct mask photolithography and mask photolithography/RIE are preferred.

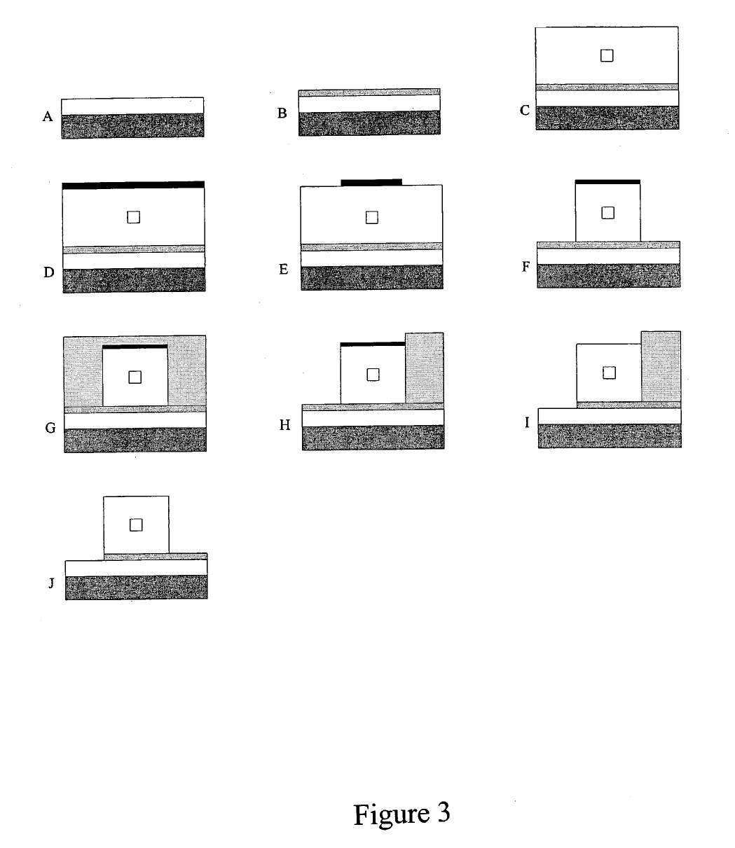

FIG. 3 depicts one method for preparing a preferred embodiment of the invention. Other processes such as those cited hereinabove may also be used. Furthermore, the same process steps may be performed in different order. For example, different patterning sequences wherein, for example, the heater may be patterned first then the waveguide aligned to it. Additionally, the device may be prepared according to the process steps shown, but the elements may be disposed in different relative positions. For example, the waveguide core does not have to be centered in the rib and the heater can be aligned differently to the waveguide.

As a general rule, it is preferred to filter all liquids and solutions through a 0.1 micrometer filter.

The steps in the process depicted in FIG. 3 make extensive use of photolithographic methods, photoresistive polymers, reactive ion etching—all processes which are well-known to one of ordinary skill in the art, in order to fabricate the thermo-optic device of the invention.

Following the procedure shown in FIG. 3, in a first step, A, a surface oxidized silicon layer≧500 micrometers in thickness is treated with (3-acryloxypropyl)trichlorosilane, and then spin-coated with a polymeric thermally insulating layer. The thickness of the thermally insulating layer is controlled by the spin speed profile, the spin time, and the temperature during spin-coating. The polymeric thermally insulating layer is preferably a photoresist or other photosensitive material that can be cured upon exposure to ultraviolet light.

In the next step, B, a resistive heating element is deposited on the cured thermally insulating layer. In the most preferred embodiment, the heating element is a layered structure comprising Cr/Au/Cr.

In the next step, C, a photosensitive polymeric cladding is spin-coated onto the heating element/thermally insulating layers and blanked exposed, a polymeric core material is spin-coated onto the layer so formed, patterned photolithographically and developed, and then additional cladding material is spin-coated and blanked exposed.

In the next step, D, a hard metal such as Ni or Cr RIE mask material is sputter coated onto the waveguide layer.

In the next step, E, the RIE mask metal layer is patterned using photolithographic methods, and in the next step, F, the exposed polymeric material is subject to RIE, thereby resulting in a polymeric mesa structure with the metal stack exposed on either side.

Steps G, H, I and J are directed to preparing the thermo-optic device for electrical connections (leads and bond pads) on one side of the device while removing the excess heater material from the other side. In Step G is deposited a polymeric mask in preparation for wet etching. In Step H the polymeric mask is patterned and developed. In Step I the excess heater material is removed, and in Step J the residual wet etching mask is removed to expose the heater leads and bond pads for connection to an electrical power supply.

In a preferred embodiment, a heater having an output power density of 1 W/cm² provides a 120° C. temperature rise in less than 50 msec, preferably less than or equal to 10 msec. Cooling takes longer than heating, and the temperature fall is also less than 50 msec, preferably less than or equal to 10 msec.

One embodiment of the present invention contemplated by the inventor hereof is a frequency selective optical communications component comprising a thermo-optic device comprising a heat sink, an optical waveguide comprising a Bragg grating, and a heating means, said heating means and said heat sink being both disposed on the same side of said optical waveguide. In one particularly preferred embodiment, a plurality of said frequency selective components are disposed upon a single chip for integration in an optical communications module. In one embodiment, individual frequency selective components of the invention will be operated at different temperatures from other said frequency selective components on said chip containing a plurality of said frequency selective components of the invention.

A Bragg grating integrated into an optical waveguide is employed to select a single narrow optical frequency from a broader spectrum of propagating signals by, for example, creating constructive interference in the reflected wave only for a very narrow frequency band. Using the thermo-optic effect to cause a shift in the refractive index of the Bragg grating causes a shift in the wavelength at which constructive interference occurs. Thus the thermo-optic effect applied to a Bragg grating provides tunability of the selected wavelength, an important feature in a frequency domain multiplexed optical communications system. In the present invention, the thermo-optic device of the invention may further comprise an optical waveguide integrally comprising a Bragg grating, thereby providing a frequency selective optical component.

A Bragg grating is produced in an optical waveguide when refractive index oscillation is created in the waveguide. Said oscillation creates refractive index mirrors, each having a reflection, and all the reflections add up constructively for some wavelength band (λ=2nΛ, where λ is the central wavelength of the reflected band, n is the effective refractive index, and Λ is the period of the grating, or of the refractive index oscillation), causing optical signals at said band to get reflected backwards, while other wavelength bands propagate forward. By using the thermo-optic effect, heat is applied to the waveguide containing the Bragg grating, the refractive index n varies, causing the reflected wavelength band λ to vary. The frequency selective optical component of the present invention exhibits a spectral shape for the selected wavelength band that can be narrow and can have a flat top.

In one particularly preferred embodiment, an antireflection coating is applied just prior to the deposition of the waveguide structure. It is believed by the inventors hereof that the antireflection coating will improve the resolution of the frequency selective device of the invention.

Further contemplated by the inventors hereof is a method for tunably selecting a portion of the frequency spectrum from a frequency domain multiplexed optical signal, the method comprising

Causing a frequency domain multiplexed optical signal to be directed to a thermo-optic device comprising a heat sink, an optical waveguide having a plurality of sides, and a heating means, said heating means and said heat sink being both disposed on the same side of said optical waveguide, and wherein said optical waveguide comprises a Bragg grating; and

Causing said thermo-optic device to be heated to a temperature corresponding to the selection of the desired frequency portion of said frequency spectrum of said frequency domain multiplexed optical signal.

The preferred embodiments of the method hereof are the preferred embodiments of the thermo-optic device therein employed.

The invention herein is further represented in the following specific embodiments thereof:

### EXAMPLE 1

In this Example, the following terms are employed

ARC is a mixture of 31.5% by weight of di-trimethylolpropane tetraacrylate, 63% by weight of tripropylene glycol diacrylate, 5% by weight of bis-(diethylamine) benzophenone, and 0.5% by weight of Darocur 4265.

B3 is a mixture of 94% by weight of ethoxylated perfluoropolyether diacrylate (MW1100), 4% by weight of di-trimethylolpropane tetraacrylate, and 2% by weight of Darocur 1173.

BF3 is a mixture of 98% by weight of ethoxylated perfluoropolyether diacrylate (MW1100) and 2% by weight of Darocur 1173.

C3 is a mixture of 91% by weight of ethoxylated perfluoropolyether diacrylate (MW1100), 6.5% by weight of di-trimethylolpropane tetraacrylate, 2% by weight of Darocur1173, and 0.5% by weight of Darocur 4265.

A 6-inch oxidized silicon wafer (substrate) was cleaned with KOH, then treated with (3-acryloxypropyl)trichlorosilane. A 17-μm-thick layer of B3 monomer was spin-deposited on the wafer, then polymerized with UV light. Successive layers of Cr, Au, and Cr were sputter deposited onto the polymer-coated waver at respective thicknesses of 10/200/10 nanometers to form a heater stack. A 20 nanometer thick layer of SiO₂ was deposited on the bottom heater stack as an adhesion layer. A 6-μm-thick layer of ARC antireflection coating was deposited onto the silica layer. Polymer waveguides were formed on said ARC using negative-tone photosensitive monomers in the following way: a 10-μm-thick BF3 underclad layer was spin-deposited and blanket cured with UV light, a C3 core layer was deposited and 7-μm×7-μm-cross-section straight waveguides were patterned in it by shining UV light through a dark-field photomask then developing the unexposed region with an organic solvent, and a 10-μm-thick B3 overclad layer was spin-deposited and blanket cured with UV light to form a thermo-optic device.

### EXAMPLE 2

A Bragg grating was formed in the waveguide of the thermo-optic device of Example 1 by UV exposure through a phase mask. A 100 nanometer Ni layer was sputter-deposited and patterned photolithographically as a mask for RIE. Said waveguides were patterned using RIE to form mesa structures around them, exposing between them the heater stack of Cr/Au/Cr. The Nickel RIE mask and Cr between mesas were completely etched, leaving a Cr/Au layer between the mesas. The wafer was electro-plated with Au, using the mesas as the plating mask. A second 100 nm Ni layer was sputter-deposited and patterned photolithographically as a mask for RIE. Said mesas were further RIE etched from both lateral sides, exposing the underlying Cr/Au/Cr. Said Nickel RIE mask and Cr between mesas and plated runs were completely etched, leaving a Cr/Au layer between the mesas, which was patterned photolithographically to isolate the resulting wavelength selective optical components.

### EXAMPLE 3 AND COMPARATIVE EXAMPLE A

A computer simulation was performed to model heat transfer and temperature profile through the thermo-optic device of the invention depicted in FIG. 2 and, for comparison, the thermo-optic device of the art depicted in FIG. 1. A commercial heat transfer software package, TempSelene, available from BBV, was employed. The following adjustable parameters were set as follows:

Parameters:

| | |
|---|---|
| Substrate: | silicon |
| Thermally insulating layer: | 10 μm |
| Underclad thickness: | 10 μm |
| Core thickness & width: | 7 μm |
| Overclad thickness: | 10 μm |
| Mesa & bottom heater width: | 27 μm |
| Bottom heater length: | 1 cm |
| Thermal conductivity of thermally | 0.1 W/m · K |
| insulating layer, underclad, core, | |
| and overclad: | |

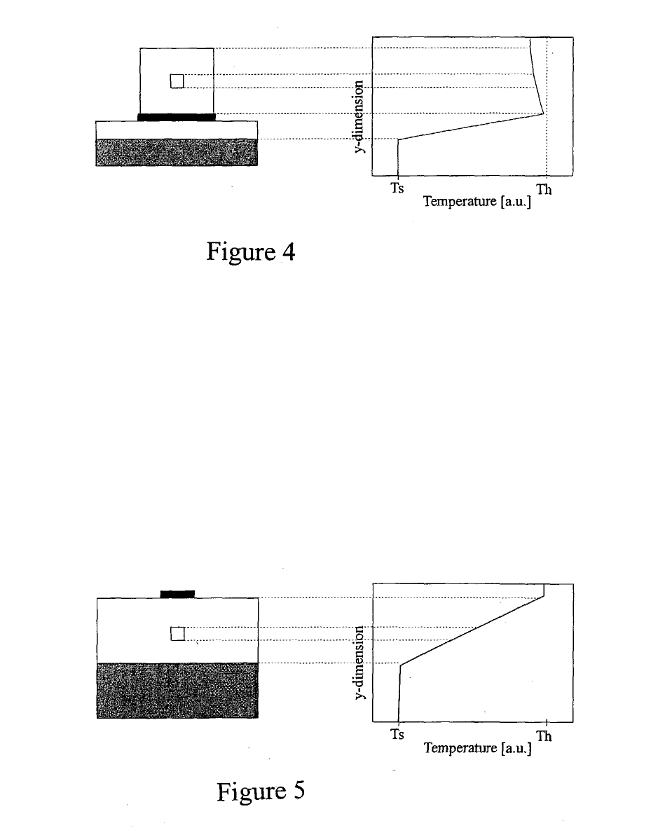

The results are depicted in FIGS. 4 and 5 respectively.

What is claimed:

1. A thermo-optic device comprising a heat sink, an optical waveguide having a plurality of sides, and a heating means, said heating means and said heat sink being both disposed on the same side of said optical waveguide.

2. The thermo-optic device of claim 1 wherein said optical waveguide is polymeric.

3. The thermo-optic device of claim 1 wherein said heating means is electrical resistance heating.

4. The thermo-optic device of claim 1 or claim 2 further comprising a thermally insulating layer disposed between said heat sink and said heating means.

5. The thermo-optic device of claim 4 wherein said thermally insulating layer is polymeric.

6. The thermo-optic device of claim 1 further comprising an anti-reflection coating disposed adjacent to said optical waveguide and on the same side of said optical waveguide as said heating means and said heat sink.

7. The thermo-optic device of claim 1, claim 2, or claim 6 wherein said optical waveguide comprises a Bragg grating.

8. A method for tunably selecting a portion of the frequency spectrum from a frequency domain multiplexed optical signal, the method comprising
Causing a frequency domain multiplexed optical signal to be directed to a thermo-optic device comprising a heat sink, an optical waveguide having a plurality of sides, and a heating means said heating means and said heat sink being both disposed on the same side of said optical waveguide, and wherein said optical waveguide comprises a Bragg grating; and
Causing said thermo-optic device to be heated to a temperature corresponding to the selection of the desired frequency portion of said frequency spectrum of said frequency domain multiplexed optical signal.

9. The method of claim 8 wherein said optical waveguide is polymeric.

10. The method of claim 8 wherein said heating means is electrical resistance heating.

11. The method of claim 8 or claim 9 wherein said thermo-optic device further comprises a thermally insulating layer disposed between said heat sink and said heating means.

12. The method of claim 11 wherein said thermally insulating layer is polymeric.

13. The method of claim 8 wherein said thermo-optic device further comprises an anti-reflection coating disposed adjacent to said optical waveguide and on the same side of said optical waveguide as said heating means and said heat sink.

14. An integrated optical communications component comprising a plurality of thermo-optic devices at least one of said thermo-optic devices comprising a heat sink, an optical waveguide having a plurality of sides, and a heating means said heating means and said heat sink being both disposed on the same side of said optical waveguide.

15. The integrated optical component of claim 14 wherein said optical waveguide is polymeric.

16. The integrated optical component of claim 14 wherein said heating means is electrical resistance heating.

17. The integrated optical component of claim 14 or claim 15 wherein said at least one of said thermo-optic devices further comprises a thermally insulating layer disposed between said heat sink and said heating means.

18. The integrated optical component of claim 14 wherein said thermally insulating layer is polymeric.

19. The integrated optical component of claim 14 wherein said at least one of said thermo-optic devices further comprises an anti-reflection coating disposed adjacent to said optical waveguide and on the same side of said optical waveguide as said heating means and said heat sink.

20. The integrated optical component of claim 14 wherein said optical waveguide comprises a Bragg grating.
